(19) United States
(12) Patent Application Publication
(10) Pub. No.: US 2009/0254535 A1
(43) Pub. Date: Oct. 8, 2009

(54) SEARCH ENGINE TO IMPROVE PRODUCT RECALL TRACEABILITY ACTIVITIES

(75) Inventors: Hans-Juergen Eickelmann, Nieder-Hilbersheim (DE); Rainer Klaus Krause, Mainz-Kostheim (DE); Thorsten Muhge, Budenheim (DE)

Correspondence Address: Oppenheimer Wolff & Donnelly LLP, Plaza VII, Suite 3300, 45 South Seventh Street, Minneapolis, MN, 55402-1609, US

(73) Assignee: International Business Machines Corporation, Armonk, NY (US)

(21) Appl. No.: 12/061,240

(22) Filed: Apr. 2, 2008

(51) Int. Cl. G06F 7/06

(52) U.S. Cl. 707/5; 707/E17.108

(57) ABSTRACT

The present invention provides an improved method of handling product recall activities through traceability. One embodiment of the present invention involves gathering data in a multi-layered database architecture containing supply, process, test, and customer layers. The data is supplied to a traceability module which contains a search engine to link and access the data. The search engine enables a search by part number, lot number, serial number, time stamp, and date/time frame. A traceability analysis is generated from the search, allowing failure analysis of the data. This analysis is performed through an event list over the entire supply, manufacturing, and customer data, facilitating backward and forward traceability of parts and components of the parts. This failure analysis further facilitates automatic response such as automatic warning and automatic recall to manufacturers and customers.

### FIELD OF THE INVENTION

The present invention relates to data traceability within database systems. The present invention specifically relates to a method of performing traceability on items in a supply, manufacturing, and customer process through a traceability architecture within a database system.

### BACKGROUND OF THE INVENTION

Requirements for traceability exist in numerous systems and industries to track the status of related products and goods. One such industry that utilizes traceability is the automotive industry, which is regulated to require the tracking of certain defective parts within vehicles. For example, there may be a product recall or callback action that requires fast identification and traceability of products containing failed parts. Manufacturers are also concerned with traceability to better accomplish warranty service and reduce reliability costs.

Existing traceability systems must be custom tailored to a particular database configuration, and fail to provide interoperability between multiple layers of data provided from disparate sources. What is needed is a method to quickly generate traceability searches on supplier data (e.g., detailed lot and shipment information), manufacturing data (e.g., detailed bill of material listings), and customer related data (e.g., locations of finished goods), and present detailed traceability search results to the user, in addition to issuing failure analysis-driven responses and warnings to interested parties.

### BRIEF SUMMARY OF THE INVENTION

One aspect of the present invention is to utilize a traceability module to pull traceability data from numerous data sources, in addition to providing a search engine and search graphical user interface to track products and components by numerous attributes. As a result of the present invention, the traceability time for tracking failed components and parts can be reduced, allowing an event tree to be generated within minutes instead of days or weeks. Additionally, the traceability management features of the present invention support immediate notifications and alerts to prevent further damage, to facilitate immediate recalls for products to prevent damage and additional cost.

The present invention may be implemented in a unique open architecture that allows existing applications, systems, and data layers to remain unchanged. This is enabled through a traceability module that interacts with data through a search engine, requiring no base system changes. The search engine employs a fast algorithm to generate an event tree which is able to start with the bill of materials (BOM) list of the final product, using dynamic layering to visualize the scope of affected components and sub-components. The last level of the event tree identifies the possible failed material locations, i.e., the location of the finished goods, to prevent further product use.

According to one embodiment of the present invention, a multi-layered database architecture is used, with a supply layer containing relevant logistical and technical data of pre-manufactured parts; a process layer containing relevant process data of materials or parts used in the manufacturing process; a test layer containing an associated database used for failure analysis; and a customer layer for controlling relevant data for finished product inventory and shipped parts.

The traceability module contains a search engine to provide access to the data within each of these database layers. A graphical user interface is also provided to allow searching of the various database layers. When a search is performed, a traceability report is generated based on search criteria. A failure analysis is created based on the analysis of the data from the numerous levels, which is generated in the form of an event tree over the entire supply, manufacturing, and customer process. Backward traceability and forward traceability is further computed to allow traceability of components and subcomponents of the products. Based on the failure analysis, a response can be generated, which may include identifying nonconforming materials and providing automatic warning and automatic product recall on both the manufacturing and customer level.

### BRIEF DESCRIPTION OF THE DRAWINGS

FIG. 1 depicts an example architecture containing numerous database layers for implementation of one embodiment of the present invention;

FIG. 2 depicts a traceability module architecture in accordance with one embodiment of the present invention;

FIG. 3A depicts a flowchart of a traceability process for a product recall action in accordance with one embodiment of the present invention;

FIG. 3B depicts a flowchart of a failure analysis and reporting process in accordance with one embodiment of the present invention;

FIG. 4 depicts a process for generating a traceability event tree performed in accordance with one embodiment of the present invention;

FIG. 5 depicts a visualization of the traceability event tree generated in accordance with one embodiment of the present invention;

FIG. 6A depicts a backward traceability process performed in accordance with one embodiment of the present invention; and

FIG. 6B depicts a forward traceability process performed in accordance with one embodiment of the present invention.

### DETAILED DESCRIPTION OF THE INVENTION

One aspect of the present invention allows traceability to be performed across an entire supply chain. The objective of performing traceability is to determine an entire event tree in case of a problem with a product, and to further obtain detailed information on all related materials, part, lot, and serial numbers, suppliers and processes, quality parameters, and material locations. This process is particularly useful in a product recall setting, where the identification of one defective part in an event tree is useful to identify defective products by product, lot, supplier, and customer.

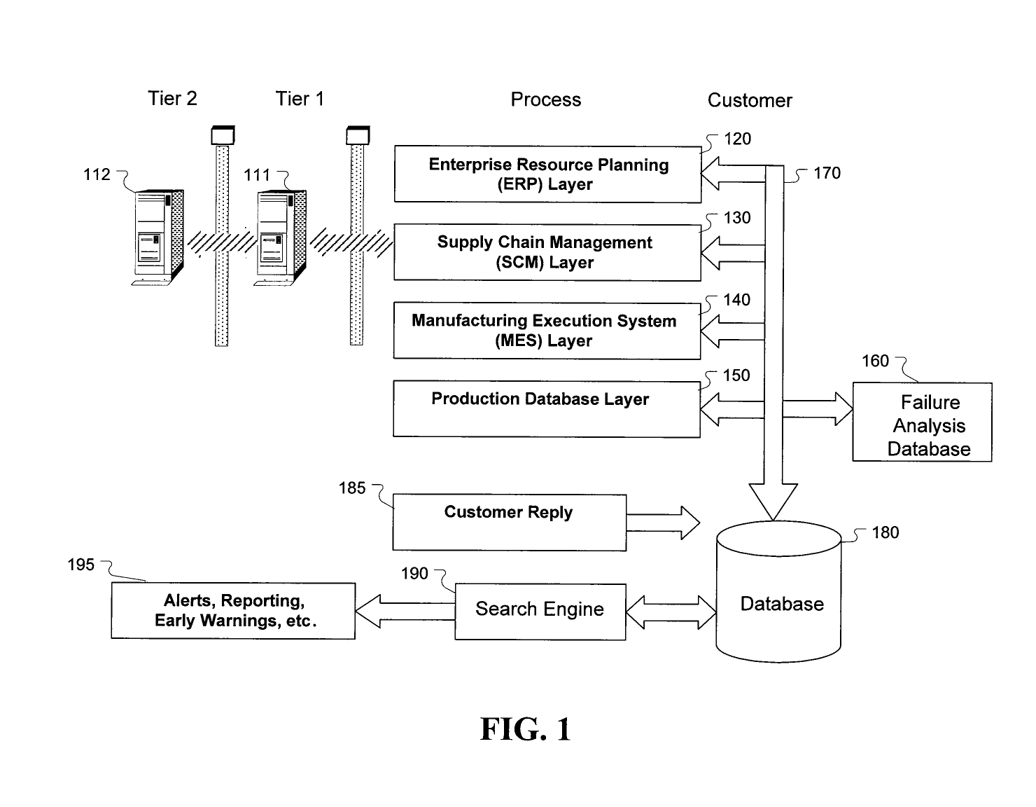

FIG. 1 depicts an example architecture for implementation of the present invention containing data within numerous layers and systems 120-150, connected to a database 180 through a generic interface 170. Supplier-related data is available in a SCM (Supply Chain Management) database layer 130 using SQUIT (Supplier Quality User Interface for Traceability). Customer process-related data is available in a Manufacturing Execution System (MES) data layer 140, a production data layer 150, as well as an Enterprise Resource Planning (ERP) data layer 120.

The material input data for the product is typically stored in the ERP layer 120, and may contain data such as part number, lot number, and supplier ID. Data used at the manufacturing floor to create the product is typically in the MES layer 140, and may contain data such as serial number, part number, lot number, and time stamp. The data in the MES layer 140 is in turn linked with the production database layer 150. The data for material output (i.e. product output) is accessible in the ERP layer 120, and may contain data including serial number, location, and customer ID.

A traceability module (TM) is utilized to pull all traceability-related data from the different layers of data 120-150 through the centralized database 180. The data collected from various product problems and failures is compiled within the Failure Analysis database 160, and may include functionality, reliability, and performance parameters. The database 180 contains a repository to list and evaluate data, and is the data store where the event tree and reports are generated from. The data within database 180 may be stored, archived, or deleted after a search is completed. Additionally, a customer reply process 185 may input further information into the database 180. As depicted, a search engine 190 provides an interface to the database 180, which facilitates the functions of alerts, early warning, and reporting 195 and the like.

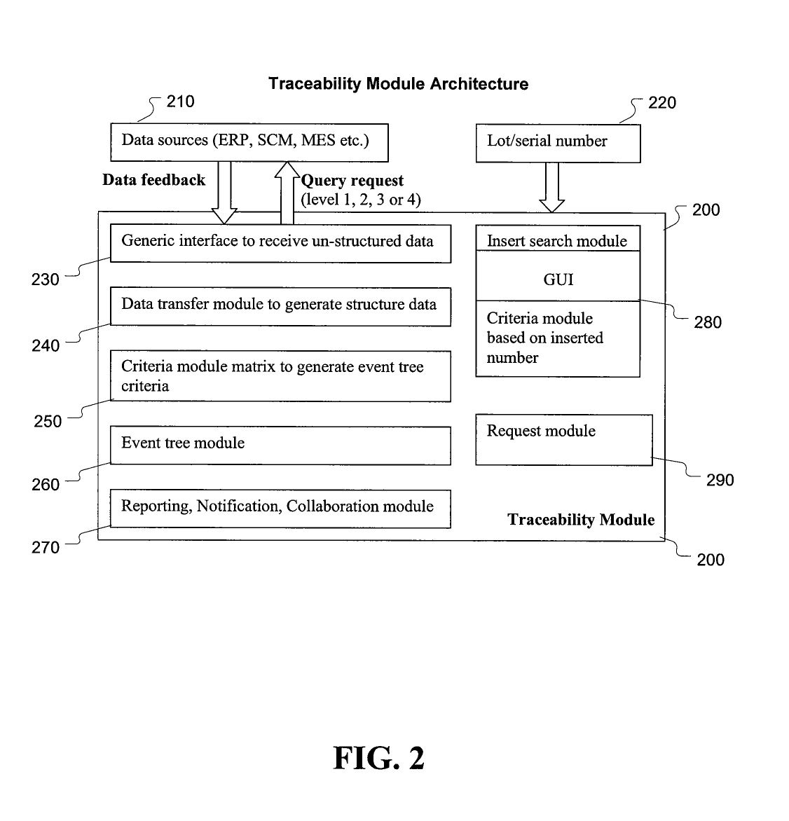

An example architecture for the traceability module in accordance with one embodiment of the present invention is depicted in FIG. 2. The traceability module 200 contains a generic interface 230 to receive unstructured data from data sources 210, the data sources that may contain distinct levels or sources, such as from the ERP, SCM, and MES data systems. The traceability module 200 is able to issue query requests to these data sources 210 and process the data feedback from the data sources 210.

Additionally, the traceability module contains a data transfer module 240 to generate structure data; a criteria module matrix 250 to generate event tree criteria; an event tree module 260 to generate event trees; a reporting, notification, and collaboration module 270 to generate each of reporting, notification, and collaboration; and a request module 290 to manage requests. The graphical user interface (GUI) 280 within the traceability module 200 contains an insert search module that the lot or serial number 200 is entered into. The GUI 280 further contains a criteria module based on the inserted number provided by the user. One embodiment of the GUI may be implemented as a web based system, such as in Java.

The database queries used in the traceability module are generic SQL which allow the use of any type of database and data structure when gathering the necessary traceability information. In the case of an incident or defect with the product, the first step is to provide the affected material or finished product lot/serial number to the traceability module search engine GUI. The database search links the failed material with the finished product serial number. The results trace a failed product component to a serial and lot number, supplier, and lot size, which allows the potentially defective product serial numbers and product locations to be determined.

The data evaluation performed by the traceability module enables the creation of an event tree, which shows the material and logistic information flow of the defective parts within the affected products. This data processing allows the scope of a product recall to potentially be determined in minutes. Thus, when an affected serial number is inputted or searched for, and the failed component is selected, an entire event tree may be presented to facilitate full traceability. Specifically, the traceability module is able to provide entire backward traceability, based on product serial number, and part, lot, or serial number. The traceability module is also capable of reporting for a material/component tree; reporting finished products affected; reporting on an affected supply base; and providing a drill-down tree containing all related material, components, and suppliers.

In a further embodiment of the present invention, the search engine GUI allows searches to be performed and search results to be reported and drilled down according to: Part number; Lot number; Serial number; Supplier; Materials; Time stamp; and Date/time frame. Additionally, the search engine supports the option to: Link the search to MES data; Link the search to production DB data; Link the search to ERP data; and Link the search to SQUIT data.

The traceability module has access to individual communication levels (ERP, SCM, MES, etc.), enabling the search engine to use top-down information to create an event tree showing how an OEM product was assembled, and which material from which supplier has been used. The traceability module further allows use of any data format in the data layers. Thus, the traceability module enables the transfer of non-structured data into structured data, for example, supplier data in SQUIT format; ERP data in SAP format; MES data in machine format, and production data in customized format.

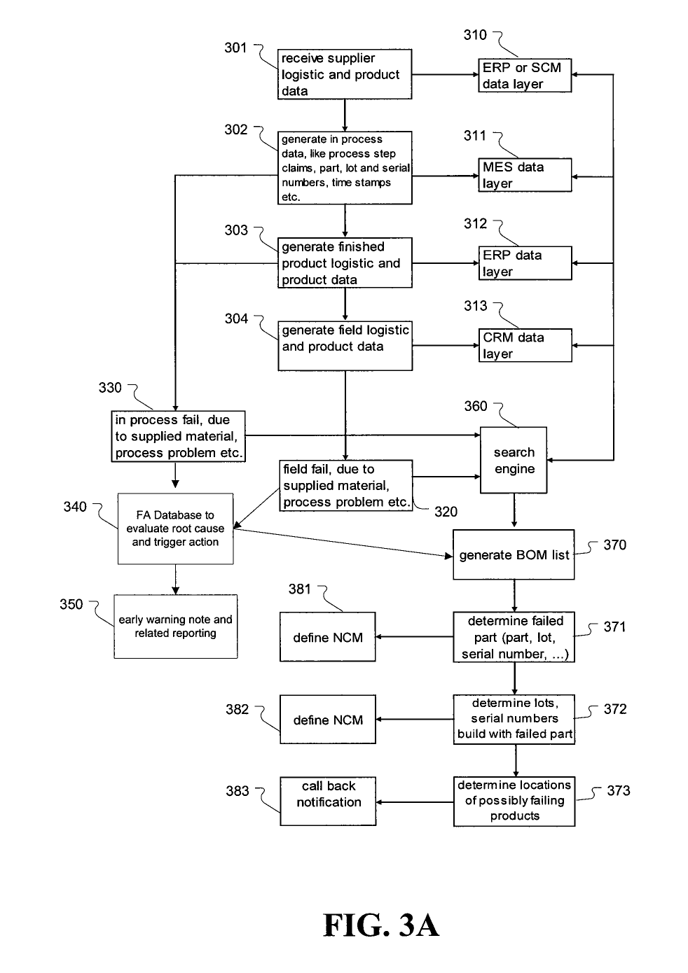

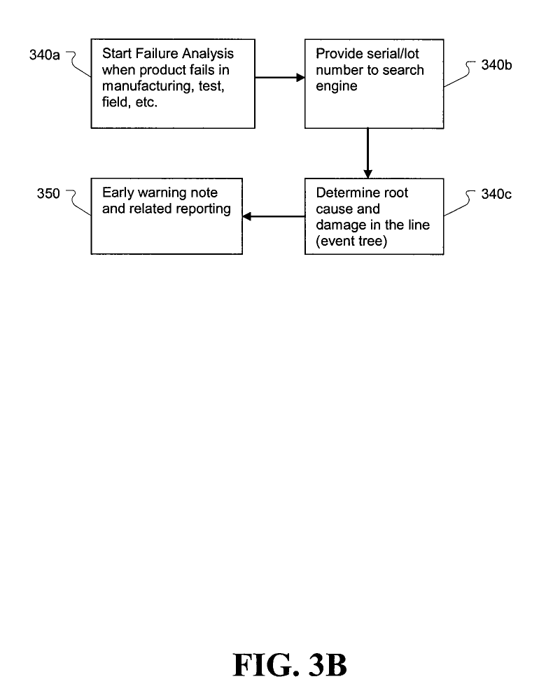

FIG. 3 depicts a flowchart depicting a traceability process for a product recall (call back) action according to one embodiment of the present invention. As depicted in FIG. 3, data is collected and generated from a number of sources in steps 301-304 which correlate to a number of data layers in steps 310-313. As depicted in step 330, when a product fails in process or in manufacturing, such as through a failure in the supplied materials or a manufacturing process, relevant data is provided to the search engine as in step 360. A similar action occurs when the product fails in the field as in step 320, such as being caused by a defective supplied material, a process problem, and the like. This traceability process may be automatically triggered through an internal failure analysis caused by manufacturing failure or field returns.

Each of the product failures provide input to the search engine as in 360 and input into the failure analysis database as in 340. As part of performing a failure analysis, a bill of materials (BOM) list is generated in 370, allowing the system to determine the failed part and information about the part, lot, serial number, and locations of possibly failing products as in steps 371-373. As depicted, the non-conforming material (NCM) can be defined as in 381-382. Once the locations of possibly failing products are determined as in 373, a call back (recall) notification is provided in 383.

FIG. 3B depicts a further embodiment of the present invention, corresponding to sub-steps of step 340 and 350 in FIG. 3A. As shown in step 340a, a failure analysis is started when a product fails in manufacturing, test, field, etc, which triggers a traceability action event tree. Next, the serial/lot number is provided to the search engine as in step 340b. This information allows the root cause and damage in the line (the event tree) to be determined as in step 340c. From this result, an early warning note and related reporting may be performed as in step 350.

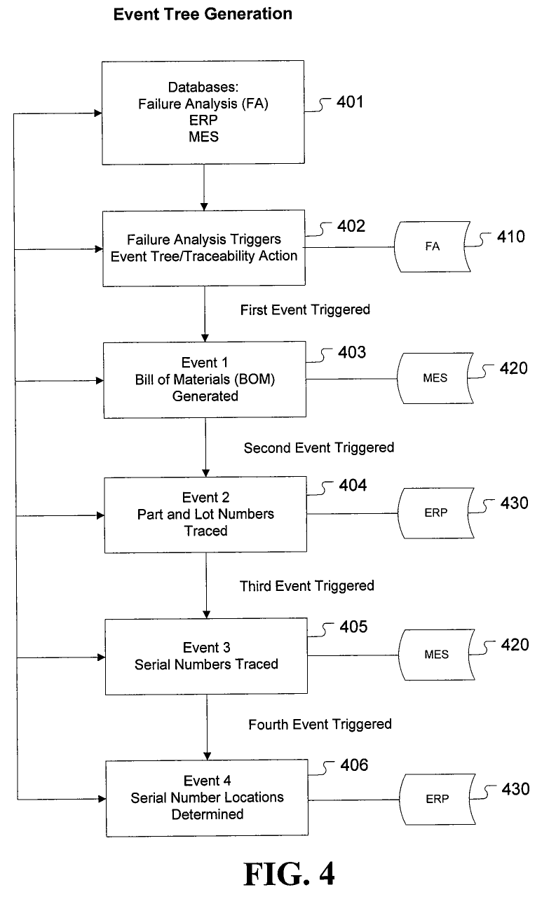

FIG. 4 is a flowchart depicting a generic generation of an event tree according to one embodiment of the present invention. As depicted, one or more databases are accessed in step 401, depicted as the failure analysis (FA) database 410, the Manufacturing Execution System (MES) database 420, and the Enterprise Resource Planning (ERP) database 430.

When a failure analysis is started, an event tree/traceability action is triggered as in step 402 with data from the failure analysis database 410, which accordingly triggers the first event. In step 403, Event 1 generates a bill of materials from the MES 420. This triggers a second event as in step 404 to trace part and lot numbers from the ERP database 430. This triggers a third event as in step 405 to trace serial numbers from the MES database 420. This triggers a fourth event as in step 406 to determine locations of the parts with the specified serial numbers from the ERP database 430.

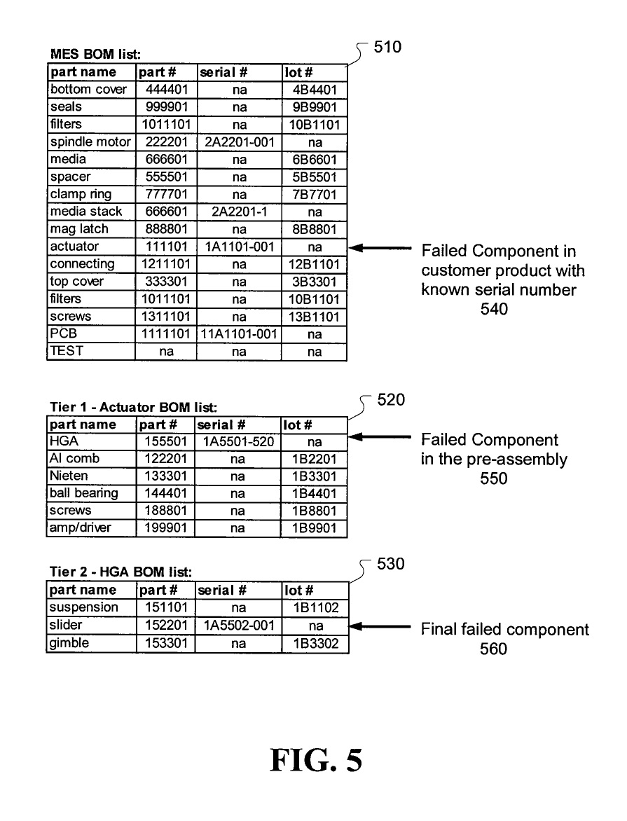

FIG. 5 depicts a visualization of the event tree generated according to one embodiment of the present invention. A Bill of Materials (BOM) list for a failed product 510 is generated from MES data. As shown in BOM list 510, a number of parts within the product are listed. The selected row 540 depicts the component which has failed—in this case, an actuator. The failed part listed in the created BOM list can be used to generate the next, underlying, BOM list of subcomponents from a tier 1 supplier.

The pre-assemble bill of materials list 520 depicts the components of the actuator pre-assembly. The selected row 550 depicts which component in the pre-assembly has failed, in this case, an HGA. Similar to the process described above, the failed part listed in the created BOM list (obtained from data within the tier 1 supplier through the ERP system) can be used to generate the next, underlying, BOM list. The list of subcomponents in the HGA pre-assembly BOM list 530 lists further sub-component parts. The selected row 560 denotes the final failed component, and is the component which caused the problem.

As described above, the process utilized by one embodiment of the present invention to generate an event tree is as follows: 1) The failed component lot number is used to generate the serial number list at the tier 1 supplier, using MES data. 2) The primary serial number list is used to generate the second serial number list, identifying the pre-assembly list, at the tier 1 supplier, using MES data. 3) The second serial number list is used to generate the final product serial number list at the customer, using MES data. 4) The product locations can be determined with the final serial number list using the ERP system.

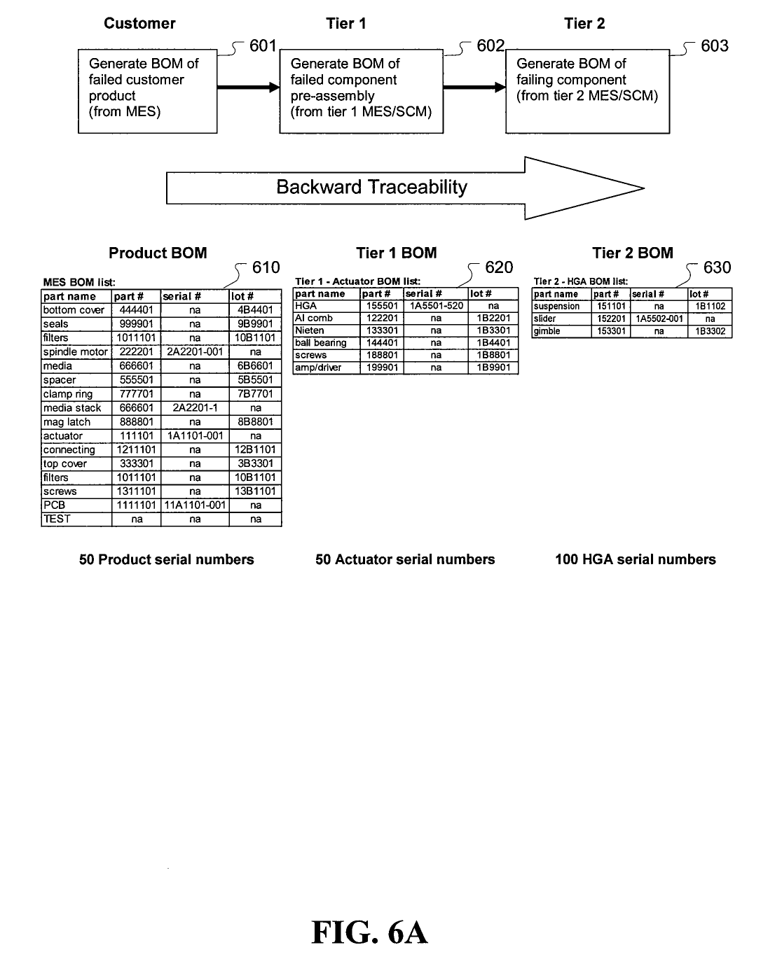

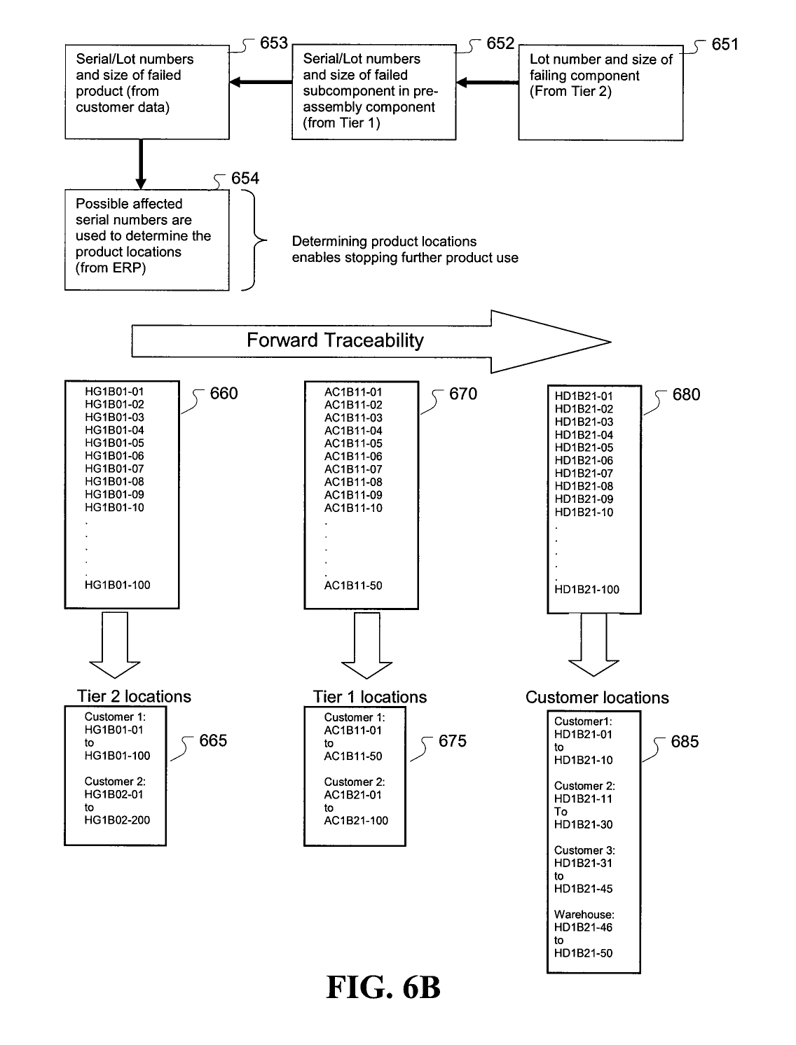

FIG. 6A further depicts the process of applying a backward traceability to determine the supplier and failing material lot or serial number according to one embodiment of the present invention. As is depicted in step 601, a failed customer product BOM 610 is generated based on data within the MES (containing 50 products within the Product BOM). The tier 1 failed component pre-assembly BOM 620 is generated from tier 1 MES/SCM data as in step 602 (with each of these actuator parts containing 50 serial numbers). The tier 2 failing component BOM 630 is generated from tier 2 MES/SCM data (with 100 serial numbers for the HGA component). Thus, backward traceability to the failing part is achieved.

FIG. 6B depicts the process of performing a forward traceability to determine the lot and serial number, as well as lot sizes of possible failing components, pre-assemblies, and products. As is depicted in Step 651, the lot number and lot size of the failing component is determined from tier 2 data. This result is depicted in list 660, which shows 100 serial numbers of the failed HGA component.

Next, the serial/lot numbers and size of the failed subcomponent in the pre-assembly component is determined from tier 1 data as in step 652. This result is depicted in list 670, showing 50 actuator serial numbers. Additionally, the serial/lot numbers and the size of the failed product are compared from customer data as in step 653.

Each of the possibly affected serial numbers determined in 660, 670, and 680 can then be traced forward per step 654 by determining the locations of the products containing the affected parts. As depicted, locations of the potentially defective product can be determined for multiple customers or storage facilities from Tier 2 data 665, tier 1 data 675, and customer data 685. Once the locations of the product are determined, the product use can be stopped, and potential recalls may be launched.

Although various representative embodiments of this invention have been described above with a certain degree of particularity, those skilled in the art could make numerous alterations to the disclosed embodiments without departing from the spirit or scope of the inventive subject matter set forth in the specification and claims.

1. A method of improving product recall traceability activities, comprising:
providing a database architecture of one or more databases executing on a plurality of database computer systems, said database architecture having a plurality of architecture layers, comprising:
a supply layer comprising a Supply Chain Management (SCM) database storing relevant logistical and technical data of product pre-manufactured parts;
a process layer comprising a Manufacturing Execution System (MES) database storing relevant process data of parts and parts materials used in the product manufacturing process;
a test layer comprising a Failure Analysis database storing product failure analysis data; and
a customer layer comprising an Enterprise Resource Planning (ERP) database storing relevant data for material input and material output, including finished product inventory and shipped parts;
providing a traceability module executing on a computer system, the traceability module including a search engine to provide access to data within the each of the plurality of architecture layers;
presenting a graphical user interface to the search engine that enables a search by part number, lot number, serial number, time stamp, and date/time frame;
searching with the search engine, wherein the search is linked to all related data stored within the plurality of architecture layers;
generating a traceability report from the search including enabling drill down functions based on inserted criteria;
analyzing data automatically from the plurality of architecture layers based on a failure analysis;
generating an event structure automatically using the Failure Analysis database for products containing one or more defective parts within supply, manufacturing, and customer processes based on related data within the plurality of architecture layers through backward traceability and forward traceability, including:
generating a bill of materials of the defective parts using the SCM and MES databases, the bill of materials listing part and lot numbers of components and subcomponents of the defective parts;
tracing part and lot numbers of the components and subcomponents using the ERP database;
tracing serial numbers of the products containing the components and subcomponents with the traced part and lot numbers using the SCM and MES databases; and
determining locations of the products with the traced serial numbers using the ERP database; and
responding to identification of the products containing the one or more defective parts with one or more of automatic warning and automatic recall to one or more of customers and manufacturers.
